(19) United States
(12) Patent Application Publication
(10) Pub. No.: US 2025/0380238 A1
(43) Pub. Date: Dec. 11, 2025

(54) METHOD, DEVICE AND COMPUTER STORAGE MEDIUM OF COMMUNICATION

(71) Applicant: NEC Corporation, Tokyo (JP)

(72) Inventor: Gang WANG, Beijing (CN)

(73) Assignee: NEC Corporation, Tokyo (JP)

(21) Appl. No.: 18/877,629

(22) PCT Filed: Jun. 21, 2022
(86) PCT No.: PCT/CN2022/100168

§ 371 Date: Dec. 20, 2024

(51) Int. Cl. H04W 64/00; H04L 5/00; H04W 8/22

(52) U.S. Cl. CPC H04W 64/00; H04L 5/0051; H04W 8/22

(57) ABSTRACT

Embodiments of the present disclosure relate to methods, devices and computer readable media of communication. A network device determines information of a repeater device and an indication indicating whether the repeater device is used for communication between the network device and a terminal device, and transmits the information of the repeater device and the indication to a positioning device for positioning the terminal device. In this way, positioning accuracy may be improved.

### TECHNICAL FIELD

Embodiments of the present disclosure generally relate to the field of telecommunication, and in particular, to methods, devices and computer storage media of communication for positioning when a network-controlled repeater (NCR) is introduced.

### BACKGROUND

Coverage is a fundamental aspect of cellular network deployments. As known, a radio frequency (RF) repeater may be utilized to simply amplify-and-forward any signal that they receive. Recently, a network-controlled repeater is introduced by adding side control information for beam management on a basis of the RF repeater. The network-controlled repeater has a capability to receive and process the side control information from a network device. However, when a network-controlled repeater is introduced in a path between a network device and a terminal device, positioning of the terminal device may be adversely affected and needs to be further developed.

### SUMMARY

In general, embodiments of the present disclosure provide methods, devices and computer storage media of communication for positioning when a network-controlled repeater is introduced.

In a first aspect, there is provided a method of communication. The method comprises: determining, at a network device, information of a repeater device and an indication indicating whether the repeater device is used for communication between the network device and a terminal device; and transmitting the information of the repeater device and the indication to a positioning device for positioning the terminal device.

In a second aspect, there is provided a method of communication. The method comprises: receiving, at a positioning device for positioning a terminal device and from a network device, information of a repeater device and an indication indicating whether the repeater device is used for communication between the network device and the terminal device; determining positioning related information provided by at least one of the network device or the terminal device; and positioning the terminal device based on the information of the repeater device, the indication and the positioning related information.

In a third aspect, there is provided a method of communication. The method comprises: receiving, at a positioning device for positioning a terminal device, location information of a repeater device from a network device; determining measurement information provided by at least one of the terminal device or the network device; and positioning the terminal device from a predetermined fingerprint associated with the location information based on the measurement information, the predetermined fingerprint comprising correspondence between a set of measurements and a set of locations of the terminal device.

In a fourth aspect, there is provided a device of communication. The device comprises a processor configured to cause the device to perform the method according to the first or second or third aspect of the present disclosure.

In a fifth aspect, there is provided a computer readable medium having instructions stored thereon. The instructions, when executed on at least one processor, cause the at least one processor to perform the method according to the first or second or third aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates an example scenario of positioning according to a conventional solution;

FIG. 3 illustrates a schematic diagram illustrating an example process of communication for positioning by a location server according to embodiments of the present disclosure;

FIG. 4 illustrates a schematic diagram illustrating an example process of communication for positioning by a terminal device according to embodiments of the present disclosure;

FIG. 5 illustrates a schematic diagram illustrating another example process of communication for positioning by a location server according to embodiments of the present disclosure;

FIG. 6 illustrates an example scenario of positioning based on a fingerprint according to embodiments of the present disclosure;

FIG. 7 illustrates an example method of communication implemented at a network device in accordance with some embodiments of the present disclosure;

FIG. 8 illustrates an example method of communication implemented at a positioning device in accordance with some embodiments of the present disclosure;

FIG. 9 illustrates another example method of communication implemented at a positioning device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “repeater” may be interchangeably used with “repeater device”, and the term “beam” may be interchangeably used with “link” or “channel”. In the context of the present application, the term “side control information” may be interchangeably used with “control information”. In the context of the present application, the term “synchronization signal and physical broadcast channel block (SSB) index” may be interchangeably used with “channel state information-reference signal (CSI-RS) index”.

Generally, in algorithms for positioning using an angle of arrival (AOA) or an angle of departure (AOD), a line of sight (LOS) path between a network device and a terminal device is assumed. However, a path between a network device and a terminal device is not a LOS path when a network-controlled repeater is used in the path, which may decrease positioning accuracy in the algorithms for positioning.

Embodiments of the present disclosure provide a solution of communication so as to overcome the above and other potential issues. In the solution, information of a repeater device is transmitted from a network device to a positioning device for use in positioning.

In one aspect, static and dynamic information of a repeater device is transmitted from a network device to a positioning device. The positioning device positions a terminal device based on the static and dynamic information of the repeater device and positioning related information provided by at least one of the network device and the terminal device. In this way, with additional information of a repeater device, positioning accuracy may be improved.

In another aspect, location information of a repeater device is transmitted from a network device to a positioning device. A fingerprint is built for an out-of-coverage area or coverage hole area associated with each repeater device. The fingerprint comprises correspondence between a set of measurements and a set of locations in the out-of-coverage area or coverage hole area. A positioning device positions a terminal device from a fingerprint associated with the location information of the repeater device based on measurement information provided by at least one of the terminal device or a network device. In this way, with additional information of a repeater device, positioning accuracy may also be improved.

Principles and implementations of the present disclosure will be described in detail below with reference to the figures.

### Example of Communication Network

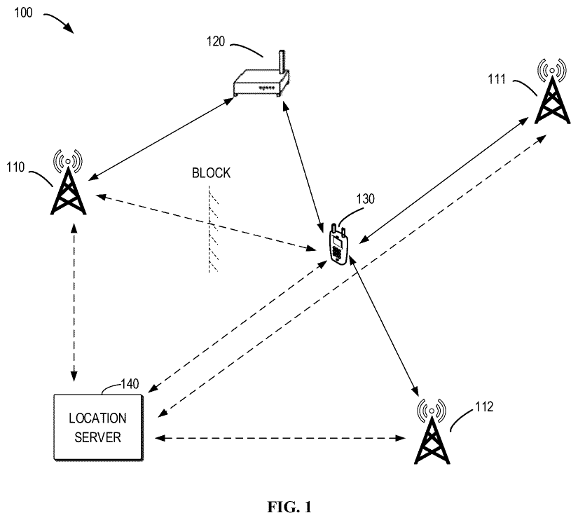

FIG. 1 illustrates a schematic diagram of an example communication network 100 in which embodiments of the present disclosure can be implemented. As shown in FIG. 1, the communication network 100 may comprise a network device 110, a repeater device 120 and a terminal device 130. The network device 110 may serve the terminal device 130.

In some embodiments, the network device 110 may directly communicate with the terminal device 130. In some embodiments, the network device 110 may communicate with the terminal device 130 via the repeater device 120. The repeater device 120 may have a forwarding function (also referred to as a normal operation mode) and a monitoring function (also referred to as a low power consumption mode). In the normal operation mode, the repeater device 120 may forward a signal transmission between the network device 110 and the terminal device 130. That is, the repeater device 120 may receive a signal from the network device 110, then amplify the received signal and forward the amplified signal to the terminal device 130. Or the repeater device 120 may receive a signal from the terminal device 130, then amplify the received signal and forward the amplified signal to the network device 110. In the low power consumption mode, the repeater device 120 may intermittently or periodically monitor a signal from the network device 110.

In some embodiments, the network device 110 may transmit side control information to the repeater device 120. The side control information may comprise at least one of the following: beamforming information, timing information to align transmission or reception boundaries of the repeater device 120, information on uplink (UL)-downlink (DL) time division duplex (TDD) configuration, on-off information for efficient interference management and improved energy efficiency, or power control information for efficient interference management.

Each of the network device 110, the repeater device 120 and the terminal device 130 may support a plurality of beams (not shown; may also referred to as access beams herein) for communication. These beams may serve as transmit beams or receive beams in DL or UL transmission.

As shown in FIG. 1, the communication network 100 may also comprise network devices 111 and 112. Similar to the network device 110, each of the network devices 111 and 112 may communicate with the terminal device 130 directly or via a repeater device that may be the repeater device 120 or another repeater device not shown. The communication network 100 may also comprise a location server 140. The location server 140 may position the terminal device 130.

It is to be understood that the number of devices in FIG. 1 is given for the purpose of illustration without suggesting any limitations to the present disclosure. The communication network 100 may involve any suitable number of network devices and/or repeater devices and/or terminal devices adapted for implementing implementations of the present disclosure.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the terminal device 130 may transmit a reference signal (RS) such as a sounding reference signal (SRS), and the network device 110, 111 or 112 may perform measurements on the RS from the terminal device 130. Based on results of the measurements, the network device 110, 111 or 112 may generate positioning related information for positioning of the terminal device 130. The network device 110, 111 or 112 may provide the positioning related information to the location server 140.

For example, the network devices 110, 111 and 112 may estimate relative time of arrival (RTOA) of SRS from the terminal device 130, and provide the RTOA to the location server 140. The location server 140 may determine a time difference of arrival (TDOA) among the RTOAs provided by the network devices 110, 111 and 112, and position the terminal device 130 based on the TDOA. This procedure may be called as a positioning based on uplink-time difference of arrival (UL-TDOA).

In some embodiments, the network device 110, 111 or 112 may transmit a RS such as a positioning reference signal (PRS), and the terminal device 130 may perform measurements on the RS from the network device 110, 111 or 112. Based on results of the measurements, the terminal device 130 may generate positioning related information for positioning of the terminal device 130. The terminal device 130 may provide the positioning related information to the location server 140.

For example, the terminal device 130 may estimate TDOA of PRSs from the network devices 110, 111 and 112, and provide the TDOA to the location server 140. The location server 140 may position the terminal device 130 based on the TDOA. This procedure may be called as a positioning based on downlink-time difference of arrival (DL-TDOA).

In some embodiments, the terminal device 130 may transmit a SRS, and the network devices 110, 111 and 112 may transmit PRSs. The network device 110, 111 or 112 may estimate RTOA between SRS reception and PRS transmission. The terminal device 130 may estimate RTOA between SRS transmission and PRS reception for each of the network devices 110, 111 and 112. The RTOAs estimated by the terminal device 130 and the network devices 110, 111 and 112 may be reported to the location server 140. The location server 140 may determine a round trip time (RTT) based on the reported RTOAs and may position the terminal device 130 based on the RTT. This procedure may be called as a positioning based on multi-cell round trip time (M-RTT).

In some embodiments, the terminal device 130 may transmit a SRS, and each of the network devices 110, 111 and 112 may estimate an angle of arrival (AOA) based on the SRS. The network devices 110, 111 and 112 may report AOAs to the location server 140. Based on the reported AOAs, the location server 140 may position the terminal device 130. This procedure may be called as a positioning based on UL-AOA.

In some embodiments, each of the network devices 110, 111 and 112 may transmit PRSs in beams, and the terminal device 130 may determine and report reference signal receiving power (RSRP) for each of the beams to the network device. Then the network device may estimate an angle of departure (AOD) based on the highest RSRP among the beams. The network device 110, 111 and 112 may report AODs to the location server 140. Based on the reported AODs, the location server 140 may position the terminal device 130. This procedure may be called as a positioning based on DL-AOD.

In some embodiments, positioning methods may be used in combination. For example, RTT may be combined with UL-AOA or DL-AOD for positioning. Of course, any other suitable combination may also feasible.

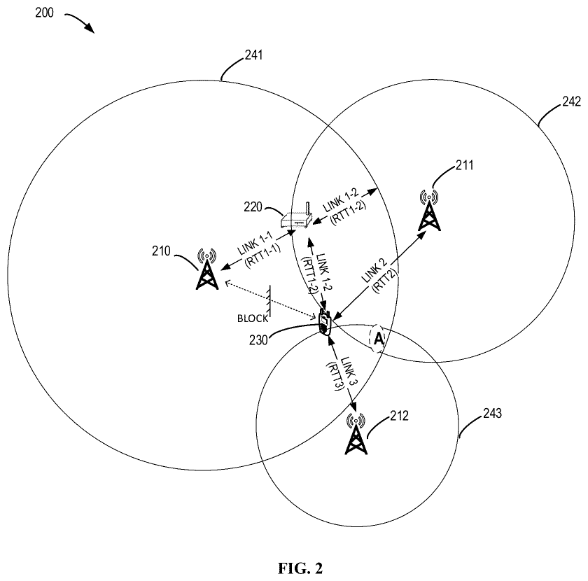

In the above positioning methods, a LOS path between a network device and a terminal device is assumed. However, when a repeater device is used for communication between a network device and a terminal device, a path between the network device and the terminal device is not a LOS path. In this case, if reported RTOA, TDOA, AOA or AOD is reused directly, positioning accuracy may be decreased. For illustration, an example will be described with reference to FIG. 2 below.

FIG. 2 illustrates an example scenario 200 of positioning according to a conventional solution. In this example, the positioning is performed based on M-RTT. As shown in FIG. 2, a network device 210 may communicate with a terminal device 230 via a repeater device 220, and network device 211 and 212 may communicate with the terminal device 230 directly. RTT1-1 is associated with a link 1-1 between the network device 210 and the repeater device 220 and RTT1-2 is associated with a link 1-2 between the repeater device 220 and the terminal device 230. As a path between the network device 210 and the terminal device 230 is considered as a LOS path, a circle 241 with the network device 210 as a center may be determined based on a total RTT of the path between network device 210 and the terminal device 230, which includes both RTT1-1 and RTT1-2.

RTT2 may be determined for a link 2 between the network device 211 and the terminal device 230 and a circle 242 with the network device 211 as a center may be determined based on RTT2. RTT3 may be determined for a link 3 between the network device 212 and the terminal device 230 and a circle 243 with the network device 212 as a center may be determined based on RTT3. Then a location of the terminal device 230 may be estimated as a cross-point A among the circles 241, 242 and 243. It can be seen that the estimated location A deviates from the actual location of the terminal device 230.

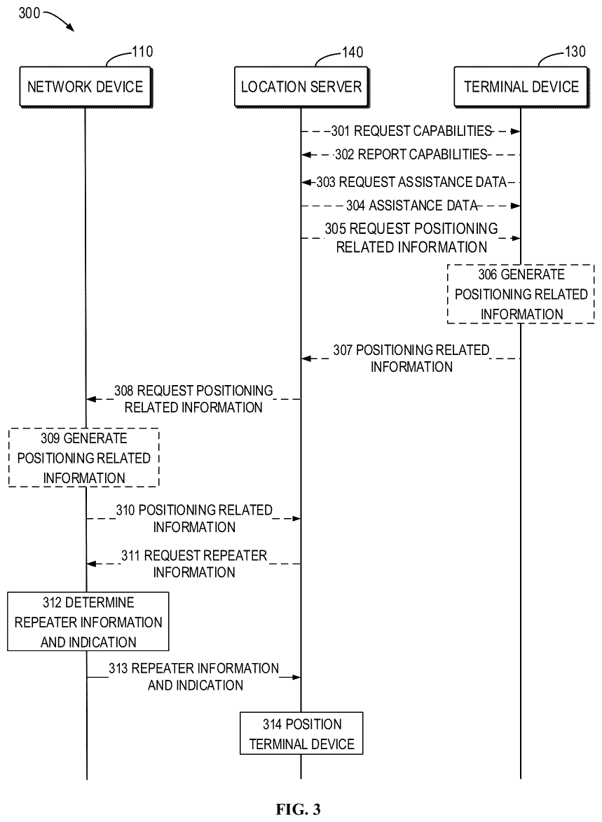

Embodiments of the present disclosure provide a solution of reporting information of a repeater device from a network device to a positioning device so as to improve positioning accuracy. In some embodiments, the positioning device may be a location server. In some embodiments, the positioning device may be a terminal device to be positioned. For illustration, some example embodiments will be described in connection with FIGS. 3 to 6.

### Example Implementation of Repeater Information Based Positioning

### 1. Positioning by Location Server

FIG. 3 illustrates a schematic diagram illustrating an example process 300 of communication for positioning by a location server according to embodiments of the present disclosure. For the purpose of discussion, the process 300 will be described with reference to FIG. 1. The process 300 may involve the network device 110, the terminal device 130 and the location server 140 as illustrated in FIG. 1. In this example, the positioning device is a location server (e.g., the location server 140).

As shown in FIG. 3, the location server 140 may transmit 301 a request for reporting capabilities of a target device to be positioned (e.g., the terminal device 130). The terminal device 130 may report 302 its capabilities to the location server 140. In some embodiments, the terminal device 130 may also transmit 303 a request for assistance data to the location server 140. The location server 140 may provide 304 the assistance data to the terminal device 130.

In some embodiments, the location server 140 may receive, from the repeater device 120 or the network device 110, an indication that the repeater device 120 has a capability of determining an AOA of a path between the repeater device 120 and the terminal device 130. In this case, the location server 140 may decide to use a positioning based on AOA for positioning the terminal device 130 when the repeater device 120 is used for communication between the network device 110 and the terminal device 130. It is to be understood that the location server 140 may consider other factors to determine a positioning method, and the present disclosure does not limit this aspect.

Continue to refer to FIG. 3, in some embodiments, e.g., for positioning based on DL-TDOA or M-RTT, the location server 140 may transmit 305 a request for reporting positioning related information to the terminal device 130. The terminal device 130 may generate 306 the positioning related information based on measurements on RSs (e.g., PRSs) from the network devices 110, 111 and 112. Then the terminal device 130 may transmit 307 the positioning related information to the location server 140.

In some embodiments, the terminal device 130 may also transmit an indication indicating that the terminal device 130 has a capability of updating the positioning related information when a trigger from the network device 110 or the location server 140 is received. Then the location server 140 may transmit a request to the terminal device 130 with a new trigger condition. For example, if the repeater device 120 is transparent to the terminal device 130, a state named “dynamicTrigger” may be added as below.

Co [symbol] mon [symbol] RequestLocationInformation [symbol] SEQUENCE {

| | |
|---|---|
| locationInformationType | LocationInformationType, |
| triggeredReporting | TriggeredReportingCriteria OPTIONAL, -- C [symbol] d [symbol] CID |

...
}
TriggeredReportingCriteria [symbol] SEQUENCE {

| | |
|---|---|
| cellC [symbol] ge | BOOLEAN, |
| reportingDuration | ReportingDuration, |
| dynamicTrigger | BOOLEAN |

...
} [symbol]
indicates data missing or illegible when filed

In some embodiments, the terminal device 130 may also transmit an indication indicating that the terminal device 130 has a capability of updating the positioning related information when the communication between the network device 110 and the terminal device 130 is switched to be performed via the repeater device 120 or without the repeater device 120 or via a further repeater device (not shown). In other words, if a device directly connected to the terminal device 130 is switched from the network device 110 to the repeater device 120, the terminal device 130 may update the positioning related information. If a device directly connected to the terminal device 130 is switched from the repeater device 120 to the network device 110, the terminal device 130 may update the positioning related information. If a device directly connected to the terminal device 130 is switched from the repeater device 120 to a further repeater device (not shown), the terminal device 130 may update the positioning related information. Then the location server 140 may transmit a request to the terminal device 130 with a new trigger condition. For example, if the terminal device 130 can identify the repeater device 120, a state named “repeaterSwitch” may be added as below.

Co [symbol] mon [symbol] RequestLocationInformation [symbol] SEQUENCE {

| | |
|---|---|
| locationInformationType | LocationInformationType, |
| triggeredReporting | TriggeredReportingCriteria OPTIONAL, -- C [symbol] d [symbol] CID |

...
}
TriggeredReportingCriteria [symbol] SEQUENCE {

| | |
|---|---|
| cellC [symbol] ge | BOOLEAN, |
| reportingDuration | ReportingDuration, |
| repeaterSwitch | BOOLEAN |

...
} [symbol]
indicates data missing or illegible when filed

It is to be understood that the above information element is merely an example, and any other suitable ways are also feasible.

Continue to refer to FIG. 3, in some embodiments, e.g., for positioning based on UL-TDOA or M-RTT, the location server 140 may transmit 308 a request for reporting positioning related information to a plurality of network devices (for convenience, the network device 110 is taken as an example). The network device 110 may generate 309 the positioning related information based on measurements on a RS (e.g., SRS) from the terminal device 130. Then the network device 110 may transmit 310 the positioning related information to the location server 140.

As shown in FIG. 3, the location server 140 may transmit 311 a request for the information of the repeater device 120. In some alternative embodiments, the network device 110 may initiatively transmit the information of the repeater device 120 without the request from the location server 140.

The network device 110 may determine 312 information of the repeater device 120 (also referred to as static information herein) and an indication (also referred to as dynamic information herein) indicating whether the repeater device 120 is used for communication between the network device 110 and the terminal device 130. Then the network device 110 may transmit 313 the information of the repeater device 120 and the indication to the location server 140.

In some embodiments, the information of the repeater device 120 may comprise a processing delay of the repeater device 120. For example, the processing delay may comprise a delay between transmission of a signal and reception of the signal. In some embodiments, the information of the repeater device 120 may comprise a transmission delay between the network device 110 and the repeater device 120. In some embodiments, the information of the repeater device 120 may comprise location information of the repeater device 120. It is to be understood that the information of the repeater device 120 may comprise any combination of the above and any other suitable information.

In some embodiments, if the repeater device 120 is removable, the network device 110 may update the location information of the repeater device 120 when a location of the repeater device 120 changes. For example, if the location of the repeater device 120 changes by a distance X, the network device 110 or the repeater device 120 itself may determine that the location of the repeater device 120 changes. In some embodiments, X may be predefined or configured. In some embodiments, X may be associated with positioning accuracy requirements of the terminal device 130. For example, the higher the required positioning accuracy is, the smaller X is, and the lower the required positioning accuracy is, the larger X is. In some embodiments, X may be associated with positioning accuracy requirements of the repeater device 120. For example, the higher the required positioning accuracy is, the smaller X is, and the lower the required positioning accuracy is, the larger X is. It is to be understood that X may also be determined in any other suitable ways.

In some embodiments, the location information of the repeater device 120 may comprise a location of the repeater device 120 or both a location of the repeater device 120 and a type of the location of the repeater device 120. In some embodiments, the type may be associated with accuracy of the location of the repeater device 120. For example, several types with different accuracy for the location of the repeater device 120 may be defined as Table 1.

TABLE 1

| Type | Name | Accuracy | Description |
|---|---|---|---|
| Type I | HardCoded | 0-0.1 m | A location is determined with network |
| | | | planning when a location of a repeater device |
| | | | is fixed. |
| Type II | MeasuredType1 | 0.1-0.5 m | A location is determined by positioning |
| | | | algorithms with high accuracy when a repeater |
| | | | device is removable. |
| Type III | MeasuredType2 | 0.5-3 m | A location is determined by positioning |
| | | | algorithms with low accuracy such as global |
| | | | navigation satellite system (GNSS) when a |
| | | | repeater device is removable. |
| Type IV | Non-available | Inf | A location of a repeater device is |
| | | | non-available, for example, when the repeater |
| | | | device is located within indoor scenarios. |

It is to be understood that Table 1 is merely an example, and the number of accuracy may be more or less.

In some embodiments, the information of the repeater device 120 may be associated with a positioning method used for the positioning of the terminal device 130.

In some embodiments for a positioning based on TDOA or M-RTT, the information of the repeater device 120 may comprise processing delay of the repeater device 120, a transmission delay between the network device 110 and the repeater device 120, and location information of the repeater device 120. In this way, RTT may be recalculated by removing influence caused by processing delay of the repeater device 120. RTT may be recalculated by removing the transmission delay between the network device 110 and the repeater device 120. A center of a circle for RTT may be changed to the location of the repeater device 120.

With the indication indicating whether the repeater device 120 is used for communication between the network device 110 and the terminal device 130, the location server 140 may determine whether to use the reported RTT and location of the network device 110 or the recalculated RTT and the reported location of the repeater device 120.

In some embodiments, the network device 110 may also transmit, to the location server 140, identity (ID) information of a RS resource. A RS carried on the RS resource is transmitted between the network device 110 and the terminal device 130 via the repeater device 120. In other words, the information of the repeater device 120 may be associated with a unique PRS resource or a unique PRS resource set, and the network device 110 may inform the unique PRS resource or the unique PRS resource set to the location server 140. For example, the ID information may comprise a DL PRS ID, PRS resource set ID and PRS resource ID. It is to be understood that the ID information may adopt any other suitable forms. With the ID information, the location server 140 may know which measurement should be recalculated.

In some embodiments for a positioning based on UL-TDOA, the network device 110 may remove the processing delay of the repeater device 120 and the transmission delay between the network device 110 and the repeater device 120, and then provide the recalculated measurements to the location server 140. In this case, only location information of the repeater device 120 and the indication indicating whether the repeater device 120 is used may be provided to the location server 140.

In some embodiments for a positioning based on AOD or AOA, the static information of the repeater device 120 may only comprise location information of the repeater device 120 (if the repeater device 120 is fixed). The dynamic information of the repeater device 120 may comprise the indication indicating whether the repeater device 120 is used.

In some embodiments for a positioning based on AOD, the network device 110 may transmit, to the terminal device 130, a configuration indicating a RS resource or a RS resource set associated with a corresponding set of indexes of access beams of a set of repeater devices associated with the network device 110. In other words, a dedicated PRS resource is allocated for each access beam of the repeater device 120.

For example, the RS resource may be associated with a set of synchronization signal and physical broadcast channel block (SSB) sub-indexes for the access beams of the set of repeater devices. In this case, an extended quasi co-location (QCL) relationship of a PRS resource for an access beam of a repeater device may be configured as below.

NR-DL-PRS-Resource- [symbol] 16 [symbol] SEQUENCE {

| | |
|---|---|
| [symbol] -DL-PRS-Resource [symbol] D- [symbol] 16 | NR-DL [symbol] PRS-Resource [symbol] D- [symbol] 16, |
| dl-PRS-Sequence [symbol] D- [symbol] 16 | INTEGER (0. [symbol] 4095), |
| dl-PRS-Co [symbol] Si [symbol] eN-An [symbol] ReOffset [symbol] 16 | CHOICE { |

```
    u2/ [symbol] 4/ [symbol] 6/u12...
    ...
  } [symbol]
```

| dl-PRS-ResourceSlotOffset- [symbol] 16 | INTEGER (0..nrMaxResourceOffsetValue- [symbol] - [symbol] 16), | |
|---|---|---|
| dl-PRS-ResourceSymbolOffset- [symbol] 16 | INTEGER (0..12), | |
| dl-PRS-QCL [symbol] - [symbol] 16 | DL-PRS-QCL [symbol] - [symbol] -16 | OPTIONAL [symbol] --N [symbol] d ON |

```
  ...
}
DL-PRS-QCL [symbol] - [symbol] - [symbol] 16 [symbol] CHOICE {
  ssb- [symbol] 16 SEQUENCE {
```

| | |
|---|---|
| p [symbol] - [symbol] 16 | NR-Phy [symbol] Cell [symbol] D- [symbol] 16, |
| ssb-Index- [symbol] 16 | INTEGER (0..63) [symbol] |
| ssb- [symbol] ub [symbol] dex | INTEGER (0..Mmax*Nmax− [symbol] ) |
| [symbol] s-T [symbol] pe- [symbol] 16 | ENUMERATED {typeC, typeD, typeC- [symbol] typeD} |

```
  } [symbol]
  dl-PRS- [symbol] 16 SEQUENCE {
```

| | |
|---|---|
| qcl-DL-PRS-Resource [symbol] D- [symbol] 16 | NR-DL-PRS-Resource [symbol] D- [symbol] 16, |
| qcl-DL-PRS-ResourceSet [symbol] D- [symbol] 16 | NR-DL-PRS-ResourceSet [symbol] D- [symbol] 16 |

}
} [symbol]
indicates data missing or illegible when filed

Where Mmax denotes the maximum number of access beams of a repeater device, and Nmax denotes the maximum number of repeater devices within a cell. In this case, each access beam of each repeater device within a serving area of a network device has a unique index (i.e., ssb-SubIndex).

As another example, the RS resource may be associated with an ID of a repeater device and a set of indexes of access beams of the repeater device. In this case, an extended quasi co-location (QCL) relationship of a PRS resource for an access beam of a repeater device may be configured as below.

NR-DL-PRS-Resource- [symbol] 16 [symbol] SEQUENCE {

| | |
|---|---|
| [symbol] -DL-PRS-Resource [symbol] D- [symbol] 16 | NR-DL [symbol] PRS-Resource [symbol] D- [symbol] 16, |
| dl-PRS-Sequence [symbol] D- [symbol] 16 | INTEGER (0.. [symbol] 095), |
| dl-PRS-Co [symbol] Si [symbol] eN-AndReOffset [symbol] 16 | CHOICE { |

```
    u2/ [symbol] 4/ [symbol] 6/u12...
    ...
  } [symbol]
```

| dl-PRS-ResourceSlotOffset- [symbol] 16 | INTEGER (0. [symbol] MaxResourceOffsetValue- [symbol] - [symbol] 16), | |
|---|---|---|
| dl-PRS-ResourceSymbolOffset- [symbol] 16 | INTEGER (0.. [symbol] 2), | |
| dl-PRS-QCL [symbol] - [symbol] 16 | DL-PRS-QCL [symbol] -Info- [symbol] - [symbol] 16 | OPTIONAL, --N [symbol] d ON |

```
  ...
}
DL-PRS-QCL [symbol] - [symbol] 16 [symbol] CHOICE {
  ssb- [symbol] 16 SEQUENCE {
```

| | |
|---|---|
| p [symbol] - [symbol] 16 | NR-Phy [symbol] Cell [symbol] D- [symbol] 16, |
| ssb-Index- [symbol] 16 | INTEGER (0..63) [symbol] |
| [symbol] cr | NR-Phy [symbol] NCR [symbol] DwithinCell |
| [symbol] dex | INTEGER (0...M [symbol] ) |
| [symbol] s-Type- [symbol] 16 | ENUMERATED {typeC, typeD, typeC-plus-typeD} |

```
  } [symbol]
  dl-PRS- [symbol] 16 SEQUENCE {
```

| | |
|---|---|
| qcl-DL-PRS-Resource [symbol] D- [symbol] 16 | NR-DL-PRS-Resource [symbol] D- [symbol] 16, |
| qcl-DL-PRS-ResourceSet [symbol] D- [symbol] 16 | NR-DL-PRS-ResourceSet [symbol] D- [symbol] 16 |

}
} [symbol]
indicates data missing or illegible when filed

Where Mmax denotes the maximum number of access beams of a repeater device. In some embodiments, an index of a repeater is allocated per network device. Then the indexes of different repeaters in serving areas of different network devices may be the same. In some embodiments, an index of a repeater is allocated for all the network devices. Then the indexes of different repeaters in serving areas of different network devices are different.

It is to be understood that any other suitable forms of configuration may also feasible, and the present application does not limit this aspect.

Accordingly, the network device 110 may determine an AOD of a path between the repeater device 120 and the terminal device 130 based on measurements on the RS resource associated with an access beam of the repeater device. For example, the network device 110 may determine the AOD of the repeater device 120 on an access link based on RSRP reported by the terminal device 130 per access beam of the repeater device 120.

In some embodiments, other information element related to access beam definition/indication for a repeater device or other information element including SSB-Index may comprise a redefined SSB-Index as below.

SSB-Index [symbol] SEQUENCE {

| ssb-Index | INTEGER (0.. [symbol] N [symbol] −1) [symbol] | |
|---|---|---|
| ssb- [symbol] ub [symbol] ndex | INTEGER (0..Mmax*Nmax− [symbol] ) | OPTIONAL |

...
} [symbol]
indicates data missing or illegible when filed

Where Mmax denotes the maximum number of access beams of a repeater device, and Nmax denotes the maximum number of repeater devices within a cell. In this case, each access beam of each repeater device within a serving area of a network device has a unique index (i.e., ssb-SubIndex).

In some alternative embodiments, other information element related to access beam definition/indication for a repeater device or other information element including SSB-Index may comprise a redefined SSB-Index as below.

SSB-Index [symbol] SEQUENCE {

| ssb- [symbol] dex | INTEGER (0.. [symbol] x [symbol] of [symbol] − [symbol] ) [symbol] | |
|---|---|---|
| ncr | NR-Phy [symbol] NCR [symbol] DwithinCell | OPTIONAL |
| ncr-SpatialFilter [symbol] dex | INTEGER (0...Mmax) | OPTIONAL |

...
} [symbol]
indicates data missing or illegible when filed

Where Mmax denotes the maximum number of access beams of a repeater device.

In some embodiments, the other information element as mentioned above may comprise any of the following: QCL-Info in TCI state, MeasResultServingCell, PerRASSBInfo, BFR-SSB-Resource, CandidateBeamRS, associatedSSB in CSI-RS-Resource-Mobility, CSI-SSB-ResourceSet, ResultsPerSSB-Index, ResultsPerSSB-IndexIdle, PUCCH-PathlossReferenceRS, PUCCH-SpatialRelationInfo, PUSCH-PathlossReferenceRS, CFRA-SSB-Resource, RadioLinkMonitoringRS, pathlossReferenceRS-Config, pathlossReferenceRS-pos, SRS-SpatialRelationInfo, SRS-SpatialRelationInfoPos, SSB-InfoNcell, etc.

In some embodiments, if the repeater device 120 is transparent to the terminal device 130 and the communication between the network device 110 and the terminal device 130 is switched to be performed via the repeater device 120 or without the repeater device 120 or via a further repeater device (not shown), the network device 110 may transmit, to the terminal device 130, an indication indicating update of positioning related information. In some embodiments, the network device 110 may transmit downlink control information (DCI) indicating the update of the positioning related information. In some embodiments, the network device 110 may transmit a medium access control (MAC) control element (CE) indicating the update of the positioning related information. In some embodiments, the network device 110 may transmit a RRC signaling indicating the update of the positioning related information. It is to be understood that any other suitable ways are also feasible to carry the indication.

In some embodiments, if the repeater device 120 supports determination of an AOA and an error in the repeater device 120 occurs, the network device 110 may transmit, to the location server 140, an indication indicating the error in the repeater device 120. For example, the network device 110 may transmit the indication in a form of forward device error causes as below. It is to be understood that any other suitable forms are also feasible.

[symbol]

CID-E [symbol] r [symbol] CHOICE {

| | |
|---|---|
| locationServerErrorCauses | [symbol] CID-LocationServerErrorCauses [symbol] |
| targetDeviceErrorCauses | [symbol] CID-TargetDeviceErrorCauses [symbol] |
| fowardDeviceErrorCauses | [symbol] CID-TargetDeviceErrorCauses [symbol] |

...
} [symbol]
indicates data missing or illegible when filed

Continue to refer to FIG. 3, the location server 140 may position 314 the terminal device 130 based on the information of the repeater device 120 and the indication provided by the network device 110 and the positioning related information provided by network devices (e.g., the network device 110, 111 and 112) and/or the terminal device 130.

In some embodiments where the location server 140 also receives the ID information of the RS resource carrying the RS that is transmitted between the network device 110 and the terminal device 130 via the repeater device 120, the location server 140 may position the terminal device 130 by adjusting, based on the information of the repeater device 120, the positioning related information associated with the RS resource.

With the process 300, a location server may position a terminal device more accurately based on information of a repeater device reported by a network device.

### 2. Positioning by Terminal device

FIG. 4 illustrates a schematic diagram illustrating an example process 400 of communication for positioning by a terminal device according to embodiments of the present disclosure. For the purpose of discussion, the process 400 will be described with reference to FIG. 1. The process 400 may involve the network device 110, the terminal device 130 and the location server 140 as illustrated in FIG. 1. In this example, the positioning device is a target device to be positioned (e.g., the terminal device 130).

As shown in FIG. 4, the location server 140 may transmit 401 a request for reporting capabilities of the terminal device 130. The terminal device 130 may report 402 its capabilities to the location server 140. In some embodiments, the terminal device 130 may also transmit 403 a request for assistance data to the location server 140. The location server 140 may provide 404 the assistance data to the terminal device 130.

In some embodiments, the location server 140 may receive, from the repeater device 120 or the network device 110, an indication that the repeater device 120 has a capability of determining an AOA of a path between the repeater device 120 and the terminal device 130. In this case, the location server 140 may decide to use a positioning method based on AOA for positioning the terminal device 130, and transmit related assistant data to terminal device 130. It is to be understood that the location server 140 may consider other factors to determine a positioning method, and the present disclosure does not limit this aspect.

As shown in FIG. 4, the location server 140 may transmit 405 a request for the information of the repeater device 120. In some alternative embodiments, the network device 110 may initiatively transmit the information of the repeater device 120 without the request from the location server 140.

The network device 110 may determine 406 information of the repeater device 120 and an indication indicating whether the repeater device 120 is used for communication between the network device 110 and the terminal device 130. The details of the determination of the information of the repeater device 120 and the indication are similar to that described in connection with 312 in FIG. 3, and thus are not repeated here for concise.

Then the network device 110 may transmit 407 the information of the repeater device 120 and the indication to the terminal device 130. In some embodiments, the network device 110 may transmit 407-1 the information of the repeater device 120 and the indication to the location server 140. The location server 140 may transmit 407-2 the information of the repeater device 120 and the indication to the terminal device 130. For example, the information of the repeater device 120 may be transmitted by the location server 140 via an information element as below. It is to be understood that this is merely an example, and any other suitable ways are also feasible. In the information element, the fields trp-ProcessingDelayAdd and trp-TransmissionDelayAdd are configured when the repeater device 120 is used for the communication between the network device 110 and the terminal device 130. The trp-ProcessingDelayAdd is the processing delay of the used repeater device 120, and the trp-TransmissionDelayAdd is the transmission delay between the repeater device 120 and the network device 110. If these two fields are included in the information element, the field RelativeLocation is updated to the location of the repeater device 120 at the same time. Then the indicated or configured delay is used for the terminal device 130 to recalculate the measurement related to time difference or time of arrival.

NR-TRP-Location [symbol] fo- [symbol] 16 [symbol] SEQUENCE (SIZE ( [symbol] n [symbol] MaxFre [symbol] Layer [symbol] - [symbol] 16)) OF [symbol] -TRP-LocationInfoPerFre [symbol] Layer- [symbol] 16
NR-TRP-Location [symbol] foPerFre [symbol] Layer- [symbol] 16 [symbol] SEQUENCE {

| | | |
|---|---|---|
| referencePoint- [symbol] 16 | ReferencePoint- [symbol] 16 OPTIONAL, | -- C [symbol] d NotSameA [symbol] P [symbol] ev |

| | |
|---|---|
| trp-LocationInfoList- [symbol] 16 | SEQUENCE (SIZE( [symbol] ..n [symbol] MaxTRPsPerF [symbol] q- [symbol] 16)) OF TRP-LocationInfoElement- [symbol] 16, |

...
}
TRP-LocationInfoElement- [symbol] 16 [symbol] SEQUENCE {

| dl-PRS-ID [symbol] - [symbol] 16 | INTEGER (0..255), | |
|---|---|---|
| [symbol] -Phy [symbol] Cell [symbol] D- [symbol] 16 | NR-Phy [symbol] Cell [symbol] D- [symbol] 16 | OPTIONAL [symbol] -- N [symbol] d ON |
| [symbol] -CellGlobal [symbol] D- [symbol] 16 | NCG [symbol] - [symbol] 15 OPTIONAL [symbol] | --N [symbol] d ON |
| [symbol] -ARFCN- [symbol] 16 | ARFCN-ValueNR- [symbol] 15 | OPTIONAL [symbol] --N [symbol] d ON |
| associated-DL-PRS- [symbol] D- [symbol] 16 | INTEGER (0..255) | OPTIONAL [symbol] -- N [symbol] d OP |
| trp-Location- [symbol] 16 | RelativeLocation- [symbol] 16 | OPTIONAL [symbol] -- N [symbol] d OP |

...

| | | |
|---|---|---|
| trp-ProcessingDelayAdd | INTEGER (0...1023) | OPTIONAL [symbol] -- N [symbol] d ON |
| trp-T [symbol] sionDelayAdd | INTEGER (0...655 [symbol] 5) | OPTIONAL [symbol] -- N [symbol] d ON |

...
}
RelativeLocation- [symbol] 16 [symbol] SEQUENCE {

| | |
|---|---|
| m [symbol] lli-arc- [symbol] -units- [symbol] 16 | ENUMERATED { m [symbol] - [symbol] 3, m [symbol] -3, m [symbol] 3, m [symbol] 30,...} [symbol] |
| height-units- [symbol] 16 | ENUMERATED { [symbol] , [symbol] , [symbol] , ...} [symbol] |
| delta-latitude- [symbol] 16 | Delta-Latitude- [symbol] 16, |
| delta-longitude- [symbol] 16 | Delta-Longitude- [symbol] 16, |
| delta-height- [symbol] 16 | Delta-Height- [symbol] 16, |
| locationUNC- [symbol] 16 | LocationUncertainty- [symbol] 16 OPTIONAL [symbol] -- N [symbol] d OP |

[symbol]

} [symbol]
indicates data missing or illegible when filed

In some alternative embodiments, the network device 110 may directly transmit 407-3 the information of the repeater device 120 and the indication to the terminal device 130. In some embodiments, the network device 110 may transmit, to the terminal device 130, information of a set of repeater devices associated with the network device 110. For each repeater device (for convenience, also referred to as a first repeater device herein) in the set of repeater devices, the information may comprise at least one of the following: a processing delay of the repeater device; a transmission delay between the network device 110 and the repeater device; or location information of the repeater device.

For example, a list of network devices may comprise a serving network device and neighboring network devices. For each network device, a repeater list or location list may be provided with a physical cell ID, a cell global ID and the like. For each of location information, delay information such as a processing delay and/or transmission delay may be appended.

In some embodiments, if the communication between the network device 110 and the terminal device 130 is switched to be performed via another repeater device (for convenience, also referred to as a second repeater device herein), the network device 110 may transmit an indication for activating a location of the second repeater device. For example, the first location among a set of locations of the set of repeater devices is a default location, and other location may be triggered by dynamic signaling from the network device 110. For example, the network device 110 may activate one location and delay information for each network device if repeater switching happens. As another example, the network device 110 may activate one location and delay information for a network device within which repeater switching happens.

For example, the network device 110 may directly transmit the information of the repeater device 120 to the terminal device 130 via an information element as below. It is to be understood that this is merely an example, and any other suitable ways are also feasible. In the information element, 1˜nrMaxNCRperTRP+1 locations of repeater devices may be configured per TRP information element, wherein nrMaxNCRperTRP denotes the maximum number of repeaters per TRP. The first one of the locations may be the location information of the TRP, the others of the locations may be the static information of each repeater device within a serving area of the TRP. For each repeater device, trp-ProcessingDelay Add is the processing delay of the used repeater device 120, trp-TransmissionDelay Add is the transmission delay between the repeater device 120 and the network device 110.

NR-TRP-Location [symbol] fo- [symbol] 16 [symbol] SEQUENCE (SIZE ( [symbol] .. [symbol] MaxFre [symbol] Layer [symbol] - [symbol] 16)) OF NR-TRP-LocationInfoPerFre [symbol] Layer- [symbol] 16
NR-TRP-Location [symbol] foPerFre [symbol] Layer- [symbol] 16 [symbol] SEQUENCE {

| | | |
|---|---|---|
| referencePoint- [symbol] 16 | ReferencePoint- [symbol] 16 OPTIONAL, | -- C [symbol] d NotSameA [symbol] P [symbol] ev |

| | |
|---|---|
| trp-LocationInfoList- [symbol] 16 | SEQUENCE (SIZE ( [symbol] ..n [symbol] MaxTRPsPerF [symbol] q- [symbol] 16)) OF TRP-LocationInfoElement- [symbol] 16, |

...
}
TRP-LocationInfoElement- [symbol] 16 [symbol] SEQUENCE {

| dl-PRS-ID [symbol] - [symbol] 16 | INTEGER (0..255), | |
|---|---|---|
| [symbol] -Phy [symbol] Cell [symbol] D- [symbol] 16 | NR-Phy [symbol] Cell [symbol] D- [symbol] 16 | OPTIONAL [symbol] -- N [symbol] d ON |
| [symbol] -CellGlobal [symbol] D- [symbol] 16 | NCG [symbol] - [symbol] 15 OPTIONAL [symbol] | -- N [symbol] d ON |
| [symbol] -ARFCN- [symbol] 16 | ARFCN-ValueNR- [symbol] 15 | OPTIONAL [symbol] -- N [symbol] d ON |
| associated-DL-PRS- [symbol] D- [symbol] 16 | INTEGER (0..255) | OPTIONAL [symbol] -- N [symbol] d OP |

| | |
|---|---|
| trp-Location- [symbol] 16 | SEQUENCE(SIZE( [symbol] .. [symbol] MaxNCRperTRP+ [symbol] )) OF trp-NCR-Locations OPTIONAL [symbol] -- N [symbol] d OP |

...
}
trp-NCR-Location [symbol] SEQUENCE {

| | | |
|---|---|---|
| trp-ProcessingDelayAdd | INTEGER (0...1023) | OPTIONAL [symbol] -- N [symbol] d ON |
| trp-T [symbol] sionDelayAdd | INTEGER (0...65535) | OPTIONAL [symbol] -- N [symbol] d ON |
| location | RelativeLocation- [symbol] 16 | OPTIONAL [symbol] -- N [symbol] d OP |

...
} [symbol]
indicates data missing or illegible when filed

Continue to refer to FIG. 4, the location server 140 may transmit 408, to the terminal device 130, a request for reporting positioning information. The terminal device 130 may position 409 the terminal device 130 based on the assistant information provided by the location server 140, information of the repeater device 120 and the indication provided by the network device 110 and positioning related information provided by network devices (e.g., the network device 110, 111 and 112) and/or the terminal device 130 itself.

In some embodiments, the network device 110 may also transmit, to the terminal device 110 directly or via the location server 140, the ID information of the RS resource carrying the RS that is transmitted between the network device 110 and the terminal device 130 via the repeater device 120. The terminal device 130 may position the terminal device 130 by adjusting, based on the information of the repeater device 120, the positioning related information associated with the RS resource.

Then the terminal device 130 may transmit 410 location information of the terminal device 130 to the location server 140.

In some embodiments, the terminal device 130 may transmit an indication indicating that the terminal device 130 has a capability of updating the positioning related information when a trigger from the network device 110 or the location server 140 is received. In some embodiments, the terminal device 130 may transmit an indication indicating that the terminal device 130 has a capability of updating the positioning related information when the communication between the network device 110 and the terminal device 130 is switched to be performed via the repeater device 120 or without the repeater device 120 or via a further repeater device (not shown). The transmission of the indication is similar to that described above in connection with FIG. 3, and thus other details are not repeated here for concise.

In some embodiments, if the repeater device 120 supports determination of an AOA and an error in the repeater device 120 occurs, the network device 110 may transmit, to the terminal device 130, an indication indicating the error in the repeater device 120. For example, the network device 110 may transmit the indication in a form of forward device error causes as described above in connection with FIG. 3. It is to be understood that any other suitable forms are also feasible.

With the process 400, a terminal device may position itself more accurately based on information of a repeater device reported by a network device.

### Example Implementation of Fingerprint Based Positioning

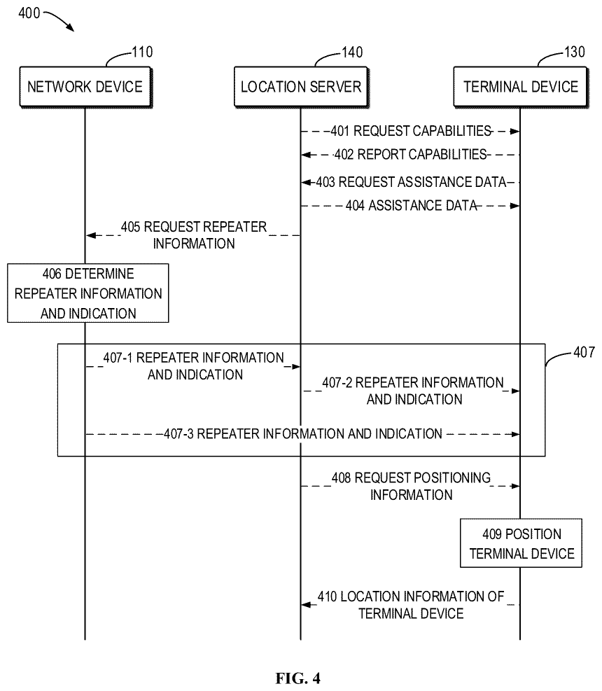

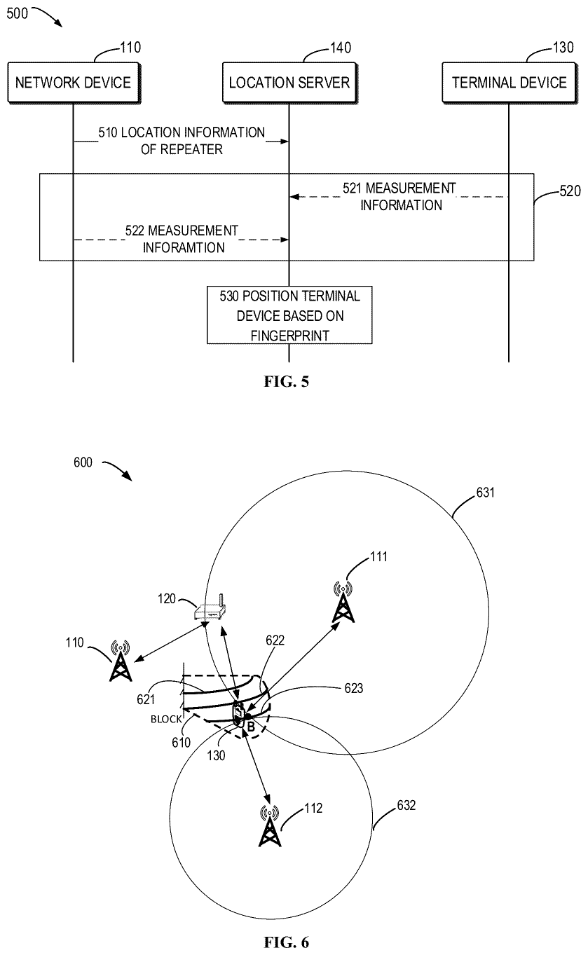

FIG. 5 illustrates a schematic diagram illustrating another example process 500 of communication for positioning by a location server according to embodiments of the present disclosure. For the purpose of discussion, the process 500 will be described with reference to FIG. 1. The process 500 may involve the network device 110 and a positioning device. The positioning device may be the terminal device 130 or the location server 140 as illustrated in FIG. 1. For convenience, the following description is given by taking the location server 140 as an example of the positioning device.

As shown in FIG. 5, the location server 140 may receive 510 location information of the repeater device 120 from the network device 110. In some embodiments, the network device 110 may transmit, to the location server 140, an indication indicating whether the repeater device 120 or which repeater device 120 is used for communication between the network device 110 and the terminal device 130. If the repeater device 120 is used for the communication between the network device 110 and the terminal device 130, the network device 110 may also transmit location information of the repeater device 120.

The location server 140 may determine 520 measurement information provided by at least one of the terminal device 130 or the network device 110. In some embodiments, the location server 140 may obtain measurement information provided by at least one of the terminal device 130 or the network device 110 based on a positioning method to be applied. For example, for a positioning based on a DL-TDOA, the location server 140 may obtain 521 measurement information from the terminal device 130. For example, for a positioning based on an UL-TDOA, the location server 140 may obtain 522 measurement information from the network device 110. For example, for a positioning based on a M-RTT, the location server 140 may obtain measurement information from both the terminal device 130 and the network device 110.

In some embodiments, the measurement information may be associated with RSRP. In some embodiments, the measurement information may be associated with RTT. In some embodiments, the measurement information may be associated with a received signal strength indicator (RSSI). In some embodiments, the measurement information may be associated with any combination of the above-listed information and any other suitable information.

The location server 140 may position the terminal device 130 from a predetermined fingerprint associated with the location information of the repeater device 120 based on the measurement information. The predetermined fingerprint may comprise correspondence between a set of measurements and a set of locations in an out-of-coverage area or coverage hole area of the network device 110, and the out-of-coverage area or coverage hole area is associated with the repeater device 120.

For illustration, an example will be described in connection with FIG. 6. FIG. 6 illustrates an example scenario 600 of positioning based on a fingerprint according to embodiments of the present disclosure. As shown in FIG. 6, the network device 110 may communicate with the terminal device 130 via the repeater device 120, and the network devices 111 and 112 may communicate with the terminal device 130 directly.

As shown in FIG. 6, as a block occurs between the network device 110 and the terminal device 130, an out-of-coverage area or coverage hole area 610 of the network device 110 may occur according to the block. At this time, the repeater device 120 is used for communication between the network device 110 and the terminal device 130. Then the out-of-coverage area or coverage hole area 610 may be associated with a location of the repeater device 120, and the relationship between the measurements and locations within the out-of-coverage area or coverage hole area 610 may be pre-stored as part of fingerprint information. Additionally, the relationship may be associated with the repeater device 120.

RTT is taken as an example. RTT1-1 may be determined for a link between the network device 110 and the repeater device 120 and RTT1-2 may be determined for a link between the repeater device 120 and the terminal device 130.

As a path between the network device 110 and the terminal device 130 is not a LOS path, the repeater device 120 may be taken as a center and curves 621, 622 and 623 may be determined based on different RTT values (e.g., RTT-1, RTT-2, RTT-3). For a curve closer to the repeater device 120, the shorter RTT may be expected. The curves 621, 622 and 623 (i.e., locations in the out-of-coverage area 610) may also be pre-stored as a part of fingerprint information and may be associated with the RTT-1, RTT-2, RTT-3 respectively. Then the relationship between value of RTT and curves are pre-stored as fingerprint information, where the RTT of location on the curve 621 is mapped to RTT-1, or RTT of location within area above the curve 621 is mapped to a value smaller than RTT-1; the RTT of location within the area between curve 621 and 622 is mapped to a value larger than RTT-1 and smaller than RTT-2. It is to be understood that any other suitable measurements such as RSRP or RSSI are also feasible to serve as fingerprint information. The present disclosure does not limit this aspect. So far, a predetermined fingerprint may be built for the out-of-coverage area 610. The predetermined fingerprint comprises correspondence between a set of measurements and a set of locations in the out-of-coverage area 610.

For example, in positioning, if information of a repeater device provided by the network device 110 indicates the location of the repeater device 120 or an index of the repeater device 120, it may be determined that the terminal device 130 is located in the out-of-coverage area 610. Next, if the location server 140 determines that measurement information is RTT-3, it may be determined, from the fingerprint built for the out-of-coverage area 610, that the terminal device 130 is located on the curve 623 corresponding to RTT-3.

RTT2 may be determined for a link between the network device 111 and the terminal device 130 and a circle 631 with the network device 111 as a center may be determined based on RTT2. RTT3 may be determined for a link between the network device 112 and the terminal device 130 and a circle 632 with the network device 112 as a center may be determined based on RTT3. Then a location of the terminal device 130 may be estimated as a cross-point B among the curve 621 and the circles 631 and 632. In this way, a location of the terminal device 220 may be positioned accurately. It is to be understood that FIG. 6 is merely for illustration, and is not intended for limitation.

With the process 500, positioning accuracy may also be improved based on information of a repeater device reported by a network device.

It to be noted that the processes 300, 400 and 500 may comprise more additional steps or omit some steps shown, and the present disclosure does not limit the order of the steps.

### Example Implementation of Methods

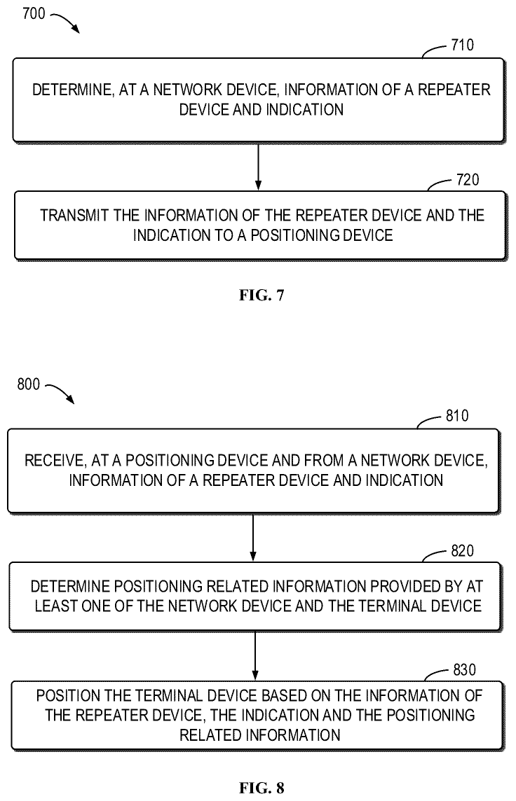

Accordingly, embodiments of the present disclosure provide methods of communication implemented at a network device and a positioning device. These methods will be described below with reference to FIGS. 7 to 9.

FIG. 7 illustrates an example method 700 of communication implemented at a network device in accordance with some embodiments of the present disclosure. For example, the method 700 may be performed at the network device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, the network device 110 determines information of the repeater device 120 and an indication indicating whether the repeater device 120 is used for communication between the network device 110 and the terminal device 130.

At block 720, the network device 110 transmits the information of the repeater device 120 and the indication to a positioning device for positioning the terminal device 130. In some embodiments, the positioning device may be the location server 140. In some embodiments, the positioning device may be the terminal device 130 per se.

In some embodiments, the information of the repeater device 120 may comprise at least one of the following: a processing delay of the repeater device 120; a transmission delay between the network device 110 and the repeater device 120; or location information of the repeater device 120. In some embodiments, if the repeater device 120 is removable, the network device 110 may update the location information of the repeater device 120 when a location of the repeater device 120 changes. In some embodiments, the location information of the repeater device 120 may comprise a location of the repeater device 120 and a type of the location of the repeater device 120. In some embodiments, the information of the repeater device 120 may be associated with a positioning method used for the positioning of the terminal device 130.

In some embodiments, the network device 110 may transmit, to the positioning device, ID information of a RS resource, a RS carried on the RS resource being transmitted between the network device 110 and the terminal device 130 via the repeater device 120.

In some embodiments, the network device 110 may transmit, to the terminal device 130, a configuration indicating a RS resource associated with a corresponding set of indexes of access beams of a set of repeater devices associated with the network device 110; and determine an AOD of a path between the repeater device 120 and the terminal device 130 based on measurements on the RS resource associated with an access beam of the repeater device 120.

In some embodiments where the positioning device is the terminal device 130, the network device 110 may transmit, to the terminal device 130, information of a set of repeater devices associated with the network device 110, the information of the set of repeater devices comprising at least one of the following: a processing delay of a first repeater device in the set of repeater devices; a transmission delay between the network device and the first repeater device; or location information of the first repeater device.

In some embodiments, if the communication between the network device 110 and the terminal device 130 is switched to be performed via a second repeater device, the network device 110 may transmit an indication for activating a location of the second repeater device.

In some embodiments, if the repeater device 120 is transparent to the terminal device 130 and the communication between the network device 110 and the terminal device 130 is switched to be performed via the repeater device 120 or without the repeater device 120 or via a further repeater device, the network device 110 may transmit, to the terminal device 130, an indication indicating update of positioning related information. In some embodiments, if the repeater device 120 supports determination of an AOA and an error in the repeater device 120 occurs, the network device 110 may transmit, to the positioning device, an indication indicating the error in the repeater device 120.

In some embodiments, the network device 110 may receive, from the location server 140, a request for the information of the repeater device 120.

In some embodiments where the positioning device is the terminal device 130, the network device 110 may transmit the information of the repeater device 120 and the indication to the location server 140 for transmission to the terminal device 130.

With the method 700, additional information of a repeater device may be provided to a positioning device for use in positioning, and thus positioning accuracy may be improved.

FIG. 8 illustrates an example method 800 of communication implemented at a positioning device in accordance with some embodiments of the present disclosure. For example, the method 800 may be performed at the location server 140 or the terminal device 130 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, a positioning device (e.g., the location server 140 or the terminal device 130) receives, from the network device 110, information of the repeater device 120 and an indication indicating whether the repeater device 120 is used for communication between the network device 110 and the terminal device 130.

At block 820, the positioning device determines positioning related information provided by at least one of the network device 110 or the terminal device 130.

At block 830, the positioning device positions the terminal device 130 based on the information of the repeater device 120, the indication and the positioning related information.

In some embodiments, the information of the repeater device 120 may comprise at least one of the following: a processing delay of the repeater device 120; a transmission delay between the network device and the repeater device 120; or location information of the repeater device 120.

In some embodiments, the positioning device may receive, from the network device 110, updating of the location information of the repeater device 120.

In some embodiments, the location information of the repeater device may comprise a location of the repeater device 120 and a type of the location of the repeater device 120.

In some embodiments, the information of the repeater device may be associated with a positioning method used for the positioning of the terminal device 130.

In some embodiments, the positioning device may receive, from the network device 110, ID information of a RS resource, a RS carried on the RS resource being transmitted between the network device 110 and the terminal device 130 via the repeater device 120. Then the positioning device may position the terminal device 130 by adjusting, based on the information of the repeater device 120, positioning related information associated with the RS resource provided by at least one of the network device 110 or the terminal device 130.

In some embodiments, no matter the positioning device is the location server 140 or the terminal device 130, the location server 140 may transmit, to the terminal device 130, a request for reporting positioning related information. Then the location server 140 may receive, from the terminal device 130, an indication indicating that the terminal device 130 has a capability of the following: updating the positioning related information when a trigger from the network device 110 or the location server 140 is received; or updating the positioning related information when the communication between the network device 110 and the terminal device 130 is switched to be performed via the repeater device 120 or without the repeater device 120 or via a further repeater device.

In some embodiments where the repeater device 120 supports determination of an AOA of a path between the repeater device 120 and the terminal device 130, the positioning device may receive an indication indicating an error in the repeater device 120.

In some embodiments, the positioning device may receive, from the repeater device 120, an indication that the repeater device has a capability of determining an AOA of a path between the repeater device 120 and the terminal device 130.

In some embodiments where the positioning device is the terminal device 130, the terminal device 130 may receive, from the network device 110 via the location server 140, the information of a repeater device 120 and the indication.

With the method 800, additional information of a repeater device may be used for positioning, and thus positioning accuracy may be improved.

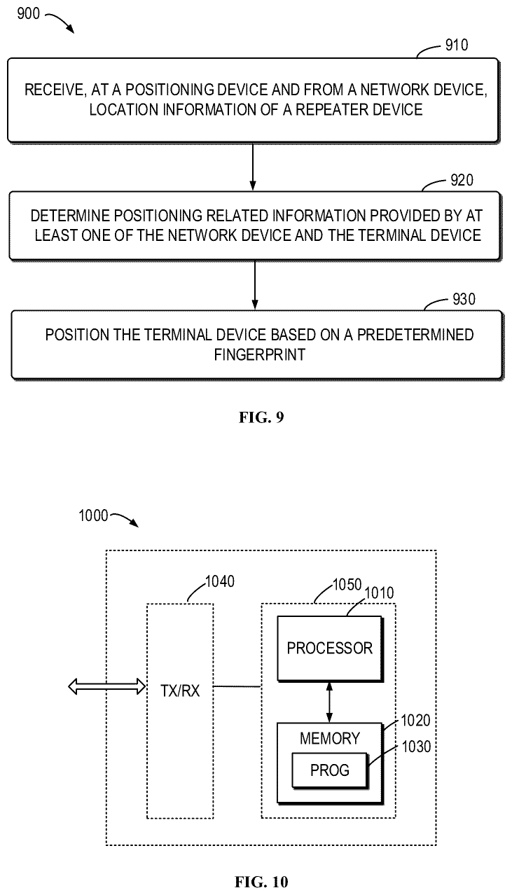

FIG. 9 illustrates another example method 900 of communication implemented at a positioning device in accordance with some embodiments of the present disclosure. For example, the method 900 may be performed at the location server 140 or the terminal device 130 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, a positioning device (e.g., the location server 140 or the terminal device 130) receives, from the network device 110, location information of the repeater device 120.

At block 920, the positioning device determines positioning related information provided by at least one of the network device 110 or the terminal device 130.

At block 930, the positioning device positions the terminal device 130 from a predetermined fingerprint associated with the location information based on the measurement information, the predetermined fingerprint comprising correspondence between a set of measurements and a set of locations.

In some embodiments, the measurement information may be associated with at least one of the following: RSRP, RTT, or RSSI.

With the method 900, a fingerprint for positioning may be built in associated with location information of a repeater device, and thus positioning accuracy may also be improved.

### Example Implementation of Device and Apparatus

FIG. 10 is a simplified block diagram of a device 1000 that is suitable for implementing embodiments of the present disclosure. The device 1000 can be considered as a further example implementation of the network device 110 or the terminal device 130 or the location server 140 as shown in FIG. 1. Accordingly, the device 1000 can be implemented at or as at least a part of the network device 110 or the terminal device 130 or the location server 140.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a network device comprises a circuitry configured to: determine information of a repeater device and an indication indicating whether the repeater device is used for communication between the network device and a terminal device; and transmit the information of the repeater device and the indication to a positioning device for positioning the terminal device.

In some embodiments, a positioning device for positioning a terminal device comprises a circuitry configured to: receive, from a network device, information of a repeater device and an indication indicating whether the repeater device is used for communication between the network device and the terminal device; determine positioning related information provided by at least one of the network device or the terminal device; and position the terminal device based on the information of the repeater device, the indication and the positioning related information.

In some embodiments, a positioning device for positioning a terminal device comprises a circuitry configured to: receive, from a network device, location information of a repeater device from a network device; determine measurement information provided by at least one of the terminal device or the network device; and position the terminal device from a predetermined fingerprint associated with the location information based on the measurement information, the predetermined fingerprint comprising correspondence between a set of measurements and a set of locations.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: determining, at a network device, information of a repeater device and an indication indicating whether the repeater device is used for communication between the network device and a terminal device; and transmitting the information of the repeater device and the indication to a positioning device for positioning the terminal device.

In some embodiments, the information of the repeater device comprises at least one of the following: a processing delay of the repeater device; a transmission delay between the network device and the repeater device; or location information of the repeater device.

In some embodiments, the method as described above further comprises: in accordance with a determination that the repeater device is removable, updating the location information of the repeater device when a location of the repeater device changes.

In some embodiments, the location information of the repeater device comprises a location of the repeater device and a type of the location of the repeater device.

In some embodiments, the information of the repeater device is associated with a positioning method used for the positioning of the terminal device.

In some embodiments, the method as described above further comprises: transmitting, to the positioning device, identity information of a reference signal resource, a reference signal carried on the reference signal resource being transmitted between the network device and the terminal device via the repeater device.

In some embodiments, the method as described above further comprises: transmitting, to the terminal device, a configuration indicating a reference signal resource associated with a corresponding set of indexes of access beams of a set of repeater devices associated with the network device; and determining an angle of departure of a path between the repeater device and the terminal device based on measurements on the reference signal resource associated with an access beam of the repeater device.

In some embodiments, the positioning device is the terminal device, and transmitting the information of the repeater device comprises: transmitting, to the terminal device, information of a set of repeater devices associated with the network device, the information of the set of repeater devices comprising at least one of the following: a processing delay of a first repeater device in the set of repeater devices; a transmission delay between the network device and the first repeater device; or location information of the first repeater device.

In some embodiments, the method as described above further comprises: in accordance with a determination that the communication between the network device and the terminal device is switched to be performed via a second repeater device, transmitting an indication for activating a location of the second repeater device.

In some embodiments, the method as described above further comprises: in accordance with a determination that the repeater device is transparent to the terminal device and the communication between the network device and the terminal device is switched to be performed via the repeater device or without the repeater device or via a further repeater device, transmitting, to the terminal device, an indication indicating update of positioning related information; or in accordance with a determination that the repeater device supports determination of an angle of arrival and an error in the repeater device occurs, transmitting, to the positioning device, an indication indicating the error in the repeater device.

In some embodiments, the method as described above further comprises: receiving, from a location server, a request for the information of the repeater device.

In some embodiments, the positioning device is the terminal device, and transmitting the information of the repeater device and the indication comprises: transmitting the information of the repeater device and the indication to a location server for transmission to the terminal device.

In another solution, a method of communication comprises: receiving, at a positioning device for positioning a terminal device and from a network device, information of a repeater device and an indication indicating whether the repeater device is used for communication between the network device and the terminal device; determining positioning related information provided by at least one of the network device or the terminal device; and positioning the terminal device based on the information of the repeater device, the indication and the positioning related information.

In some embodiments, the information of the repeater device comprises at least one of the following: a processing delay of the repeater device; a transmission delay between the network device and the repeater device; or location information of the repeater device.

In some embodiments, the method as described above further comprises: receiving, from the network device, updating of the location information of the repeater device.

In some embodiments, the location information of the repeater device comprises a location of the repeater device and a type of the location of the repeater device.

In some embodiments, the information of the repeater device is associated with a positioning method used for the positioning of the terminal device.

In some embodiments, positioning the terminal device comprises: receiving, from the network device, identity information of a reference signal resource, a reference signal carried on the reference signal resource being transmitted between the network device and the terminal device via the repeater device; and positioning the terminal device by adjusting, based on the information of the repeater device, positioning related information associated with the reference signal resource provided by at least one of the network device or the terminal device.

In some embodiments, the method as described above further comprises: transmitting, at a location server and to the terminal device, a request for reporting positioning related information; and receiving, at the location server and from the terminal device, an indication indicating that the terminal device has a capability of the following: updating the positioning related information when a trigger from the network device or the location server is received; or updating the positioning related information when the communication between the network device and the terminal device is switched to be performed via the repeater device or without the repeater device or via a further repeater device.

In some embodiments, the repeater device supports determination of an angle of arrival of a path between the repeater device and the terminal device. In these embodiments, the method as described above further comprises: receiving an indication indicating an error in the repeater device.

In some embodiments, the method as described above further comprises: receiving, from the repeater device, an indication that the repeater device has a capability of determining an angle of arrival of a path between the repeater device and the terminal device.

In some embodiments, the positioning device is the terminal device, and receiving the information of a repeater device and the indication comprises: receiving, from the network device via a location server, the information of a repeater device and the indication.

In another solution, a method of communication comprises: receiving, at a positioning device for positioning a terminal device, location information of a repeater device from a network device; determining measurement information provided by at least one of the terminal device or the network device; and positioning the terminal device from a predetermined fingerprint associated with the location information based on the measurement information, the predetermined fingerprint comprising correspondence between a set of measurements and a set of locations.

In some embodiments, the measurement information is associated with at least one of the following: reference signal receiving power, round trip time, or received signal strength indicator.

In some embodiments, the positioning device is the terminal device or a location server.

In another solution, a device of communication comprises: a processor configured to cause the device to perform the method according to the solutions as described above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
determining, at a network device, information of a repeater device and an indication indicating whether the repeater device is used for communication between the network device and a terminal device; and
transmitting the information of the repeater device and the indication to a positioning device for positioning the terminal device.

2. The method of claim 1, wherein the information of the repeater device comprises at least one of the following:
a processing delay of the repeater device;
a transmission delay between the network device and the repeater device; or
location information of the repeater device.

3. The method of claim 2, further comprising:
in accordance with a determination that the repeater device is removable, updating the location information of the repeater device when a location of the repeater device changes.

4. The method of claim 2, wherein the location information of the repeater device comprises a location of the repeater device and a type of the location of the repeater device.

5. The method of claim 1, wherein the information of the repeater device is associated with a positioning method used for the positioning of the terminal device.

6. The method of claim 1, further comprising:
transmitting, to the positioning device, identity information of a reference signal resource, a reference signal carried on the reference signal resource being transmitted between the network device and the terminal device via the repeater device.

7. The method of claim 1, further comprising:
transmitting, to the terminal device, a configuration indicating a reference signal resource associated with a corresponding set of indexes of access beams of a set of repeater devices associated with the network device; and
determining an angle of departure of a path between the repeater device and the terminal device based on measurements on the reference signal resource associated with an access beam of the repeater device.

8. The method of claim 1, wherein the positioning device is the terminal device, and wherein transmitting the information of the repeater device comprises:
transmitting, to the terminal device, information of a set of repeater devices associated with the network device, the information of the set of repeater devices comprising at least one of the following:
a processing delay of a first repeater device in the set of repeater devices;
a transmission delay between the network device and the first repeater device; or
location information of the first repeater device.

9. The method of claim 8, further comprising:
in accordance with a determination that the communication between the network device and the terminal device is switched to be performed via a second repeater device, transmitting an indication for activating a location of the second repeater device.

10. The method of claim 1, further comprising:
in accordance with a determination that the repeater device is transparent to the terminal device and the communication between the network device and the terminal device is switched to be performed via the repeater device or without the repeater device or via a further repeater device, transmitting, to the terminal device, an indication indicating update of positioning related information; or
in accordance with a determination that the repeater device supports determination of an angle of arrival and an error in the repeater device occurs, transmitting, to the positioning device, an indication indicating the error in the repeater device.

11. The method of claim 1, further comprising:
receiving, from a location server, a request for the information of the repeater device.

12. The method of claim 1, wherein the positioning device is the terminal device, and wherein transmitting the information of the repeater device and the indication comprises:
transmitting the information of the repeater device and the indication to a location server for transmission to the terminal device.

13. A method of communication, comprising:
receiving, at a positioning device for positioning a terminal device and from a network device, information of a repeater device and an indication indicating whether the repeater device is used for communication between the network device and the terminal device;
determining positioning related information provided by at least one of the network device or the terminal device; and
positioning the terminal device based on the information of the repeater device, the indication and the positioning related information.

14. The method of claim 13, wherein the information of the repeater device comprises at least one of the following:
a processing delay of the repeater device;
a transmission delay between the network device and the repeater device; or
location information of the repeater device.

15. The method of claim 14, further comprising:
receiving, from the network device, updating of the location information of the repeater device.

16. The method of claim 14, wherein the location information of the repeater device comprises a location of the repeater device and a type of the location of the repeater device.

17. The method of claim 13, wherein the information of the repeater device is associated with a positioning method used for the positioning of the terminal device.

18. The method of claim 13, wherein positioning the terminal device comprises:
receiving, from the network device, identity information of a reference signal resource, a reference signal carried on the reference signal resource being transmitted between the network device and the terminal device via the repeater device; and
positioning the terminal device by adjusting, based on the information of the repeater device, positioning related information associated with the reference signal resource provided by at least one of the network device or the terminal device.

19. The method of claim 13, wherein the method further comprises:
transmitting, at a location server and to the terminal device, a request for reporting positioning related information; and
receiving, at the location server and from the terminal device, an indication indicating that the terminal device has a capability of the following:
updating the positioning related information when a trigger from the network device or the location server is received; or
updating the positioning related information when the communication between the network device and the terminal device is switched to be performed via the repeater device or without the repeater device or via a further repeater device.

20. A device of communication comprising:
a processor configured to cause the device to perform the method according to claim 1.
